(19) United States
(12) Patent Application Publication
(10) Pub. No.: US 2023/0271739 A1
(43) Pub. Date: Aug. 31, 2023

(54) DEVICE FOR LABELING CONTAINERS

(71) Applicant: KRONES AG, Neutraubling (DE)

(72) Inventors: Michael NEUBAUER, Grassau (DE); Wolfgang ROIDL, Deuerling (DE); Hartmut DAVIDSON, Zeitlarn (DE); Stefan SCHERL, Bernhardswald (DE); Heinrich BIELMEIER, Pilsting - Grosskoellnbach (DE)

(21) Appl. No.: 18/016,415

(22) PCT Filed: Jul. 22, 2021
(86) PCT No.: PCT/EP2021/070556

§ 371 Date: Jan. 16, 2023

(30) Foreign Application Priority Data
Jul. 31, 2020 (DE) 10 2020 120 288.1

(51) Int. Cl. B65C 9/08; B65C 9/02; B65C 9/26; B65C 3/06; B65C 9/20

(52) U.S. Cl. CPC B65C 9/08; B65C 9/02; B65C 9/26; B65C 3/065; B65C 9/20

(57) ABSTRACT

The invention relates to a device (10A-10E) for labeling containers (12). The device (10A-10E) has a container conveyor (14) for conveying containers (12) and at least one label dispenser (18) for providing labels. The device (10A-10E) has at least one planar drive system (16A-16E) which is configured so as to transport labels from the at least one label dispenser (18) to the container conveyor (14) in order to apply the label onto the containers (12). The device can improve flexibility during labeling processes.

### TECHNICAL FIELD

The invention relates to a device for labeling containers.

### TECHNICAL BACKGROUND

Container processing systems can have labeling machines for labeling containers, e.g. bottles and cans.

Labeling machines are known, for example, from DE 197 41 476 A1. In the labeling machine described there, a turntable is mounted rotatably on a table top arranged on an underframe. Labeling assemblies are arranged on the circumference of the turntable, the labeling assemblies serving to apply labels to the vessels transported on the turntable. For this purpose, each labeling assembly has its own motor with which it forms a spatially closed unit. This unit is arranged on the turntable.

Owing to the labeling assemblies, it is possible to adapt the labeling machine to various equipment variants and/or types of vessel, for example to different bottles. For this purpose, the assemblies together with their associated motors can be removed from the table top and replaced by new assemblies which correspond to the changed vessels and have their own motors.

In addition, there are linear runners which dispense the label directly onto the bottle (e.g. sleeve machines or sleeve label machines).

The invention is based on the object of providing an alternative and/or improved device for labeling containers, preferably for increasing flexibility and for reducing a retooling time for different equipment variants or types of vessel.

The invention is based on the object of providing an alternative and/or improved device for labeling containers, preferably for increasing flexibility and for reducing a retooling time for different label variants or types of vessel.

### SUMMARY OF THE INVENTION

The object is achieved by the features of independent claim 1. Advantageous developments are specified in the dependent claims and the description.

One aspect of the present disclosure relates to a device for labeling containers. The device has a (e.g. single-track) container conveyor for conveying containers. The device has at least one label dispenser for providing labels. The device has a planar drive system which is configured (e.g. by means of a control unit) to transport labels from the at least one label dispenser to the container conveyor for applying to the containers.

The device provides great flexibility in respect of labeling containers. Different labeling features are made possible down to labeling a container on an individual basis (“labeling on demand”). The device can be adapted to different container shapes, container sizes, container infeed distances, etc. without retooling. For this purpose, for example, just a changed control of the movement devices of the planar drive system may be required. The planar drive system does not have any contacting parts, and therefore it operates substantially free from wear. In contrast to a container carousel for labeling containers, there is no large rotating mass which has to be driven. In addition, movement devices can carry out certain movements during the actual labeling operation that improve the labeling. For example, the movement devices can be inclined, rotated, lifted or lowered with respect to the base element during the labeling operation. In principle, the device disclosed herein also affords the option of being connected to different basic machines or conveyors. This flexibility relates, for example, to the connection to various basic machine part circuits, various basic machine divisions, connection to carousels and linear machines, etc.

The planar drive system can preferably be a magnetic planar drive system.

In one exemplary embodiment, the planar drive system has a (e.g. flat) base element and at least one movement device. Preferably, the at least one movement device can be movable by means of magnetic interaction with the base element to the at least one label dispenser for receiving a label and to the container conveyor for applying the received label to a container.

Preferably, the at least one movement device can be movable by means of magnetic interaction with the base element back again to the at least one label dispenser after the received label has been applied.

The at least one movement device can preferably be supported contactlessly by the base element, preferably on an upper side or lower side of the base element, by means of magnetic interaction.

It is also possible for labels which have dried on during or after a production interruption to be removed from the at least one movement device.

In a further exemplary embodiment, the at least one movement device has a label holder for holding a label (and preferably for receiving a label from the at least one label dispenser and/or for applying it to a container).

In a development, the label holder has a label gripper, a label clamping holder, a label suction unit, a label support unit and/or a labeling pallet.

In an embodiment variant, the planar drive system is configured (e.g. by means of a control unit) such that the at least one movement device moves along with a container on the container conveyor, preferably at the same speed, and, in the process, applies the label to the container. The application of the label can thus be advantageously improved, in particular even at very high speeds.

A speed of the at least one movement device can preferably be variably adapted to different speeds of the containers on the container conveyor.

In a further embodiment variant, the planar drive system is configured (e.g. by means of a control unit) such that the at least one movement device stops, slows down, speeds up and/or carries out a predetermined movement pattern at the at least one label dispenser in order to receive the label. The transfer of the label can therefore be improved.

In a further embodiment variant, the at least one label dispenser has a sleeve label dispenser for providing (e.g. stretchable) sleeve labels. The planar drive system (e.g. the base element thereof) can preferably be oriented in a vertical plane.

In a development, the planar drive system is configured (e.g. by means of a control unit) such that the at least one movement device moves along with a container on the container conveyor, preferably at the same speed, and, in the process, applies the transported sleeve label by means of pulling it over the container, preferably by lowering of the at least one movement device.

In an exemplary embodiment, the at least one label dispenser has a plurality of label dispensers which dispense different labels (e.g. different shape, color, size, imprint, decoration, self-adhesive or not, etc.).

In a development, the planar drive system is configured (e.g. by means of a control unit) to transport the different labels from the plurality of label dispensers to different containers for applying to the containers, preferably for on-demand labeling on an individual container basis. Alternatively, the planar drive system can be configured (e.g. by means of a control unit) to transport the different labels from the plurality of label dispensers to the identical containers for applying to the containers, preferably for mixed labeling of the containers. It is also possible for the same planar drive system to be switched over between these two configurations.

In a further exemplary embodiment, the at least one label dispenser has a plurality of label dispensers which dispense identical labels.

In a development, the planar drive system is configured (e.g. by means of a control unit) to transport the identical labels from a plurality of label dispensers to different containers for applying to the containers. By means of a parallel receiving of labels and optionally application of labels, a throughput, for example, can be increased.

In one embodiment, the containers conveyed by the container conveyor have different sizes (e.g. diameters) and/or shapes (e.g. can be detected by means of a sensor system of the device). The planar drive system can preferably be configured (e.g. by means of a control unit) to move the at least one movement device substantially always identically closely to the containers having the different sizes and/or shapes for applying the labels. The planar drive system can therefore be used flexibly for various types of container.

In a further embodiment, the planar drive system is configured (e.g. by means of a control unit) to incline the at least one movement device with respect to the base element during the application of the label, preferably for applying it to an inclined portion of the containers (e.g. neck region). Alternatively or additionally, the planar drive system can be configured (e.g. by means of a control unit), for example, to rotate the at least one movement device with respect to the base element, preferably about its own center axis, during the application of the label. The attaching of the label can thus be advantageously improved.

In an embodiment variant, the planar drive system is configured (e.g. by means of a control unit) to move the at least one movement device at different distances (e.g. detected by means of a sensor system) along the container conveyor for adaptation to different distances between the containers.

In a further embodiment variant, the planar drive system is configured (e.g. by means of a control unit) not to move a movement device with a label to a container gap (e.g. detected by means of a sensor system) between the otherwise identically spaced-apart containers.

In one exemplary embodiment, the device can furthermore have a gluing unit for gluing labels. The planar drive system can preferably be configured (e.g. by means of a control unit) to transport the labels from the at least one label dispenser to the gluing unit for gluing and to transport the glued labels to the container conveyor for applying to the containers.

In a development, the at least one movement device is movable by means of magnetic interaction with the base element to the gluing unit for gluing the received label and/or from the gluing unit to the container conveyor.

The base element can preferably be substantially frame-shaped, rectangular, circular or annular. In principle, the base element can therefore be adapted to different system layouts and construction space conditions. The planar drive system with the circular base element can be particularly suitable, for example, for replacing rotating labeling machines in already existing container processing systems, with the system layout not having to be changed.

The gluing unit and/or the label dispenser can preferably be arranged on the outer side or inner side of the base element.

The device as disclosed herein can preferably be used in a container processing system (e.g. for producing, cleaning, checking, filling, closing, labeling, imprinting and/or packaging containers for liquid media, preferably beverages or liquid foodstuffs).

It is possible for the planar drive system to be arranged along the container conveyor, preferably adjacent to the container conveyor.

It is also possible for the planar drive system (e.g. the base element thereof) to be oriented in a horizontal plane.

For example, the container conveyor can be a (e.g. single-track) linear conveyor (e.g. belt conveyor) or a carousel conveyor.

Preferably, the term “control unit” can refer to an electronic unit (e.g. with microprocessor(s) and data memory) which can perform open-loop control tasks and/or closed-loop control tasks and/or processing tasks, depending on the design. Even if the term “control” is used herein, it can also usefully include or mean “closed-loop control” or “control with feedback” and “processing”.

The preferred embodiments and features of the invention which are described above can be combined with one another as desired.

### BRIEF DESCRIPTION OF THE FIGURES

Further details and advantages of the invention are described below with reference to the attached drawings, in which:

FIG. 1 shows a schematic top view of a device for labeling containers according to an exemplary embodiment of the present disclosure;

FIG. 2 shows a schematic top view of a device for labeling containers according to a further exemplary embodiment of the present disclosure;

FIG. 3 shows a schematic top view of a device for labeling containers according to a further other exemplary embodiment of the present disclosure;

FIG. 4 shows a schematic top view of a device for labeling containers according to a further other exemplary embodiment of the present disclosure; and

FIG. 5 shows a schematic side view of a device for labeling containers according to a further other exemplary embodiment of the present disclosure.

The embodiments shown in the figures are at least partially identical, and therefore similar or identical parts are provided with the same reference signs, and reference is also made, for their explanation, to the description of the other embodiments or figures in order to avoid repetition.

### DETAILED DESCRIPTION OF EXEMPLARY EMBODIMENTS

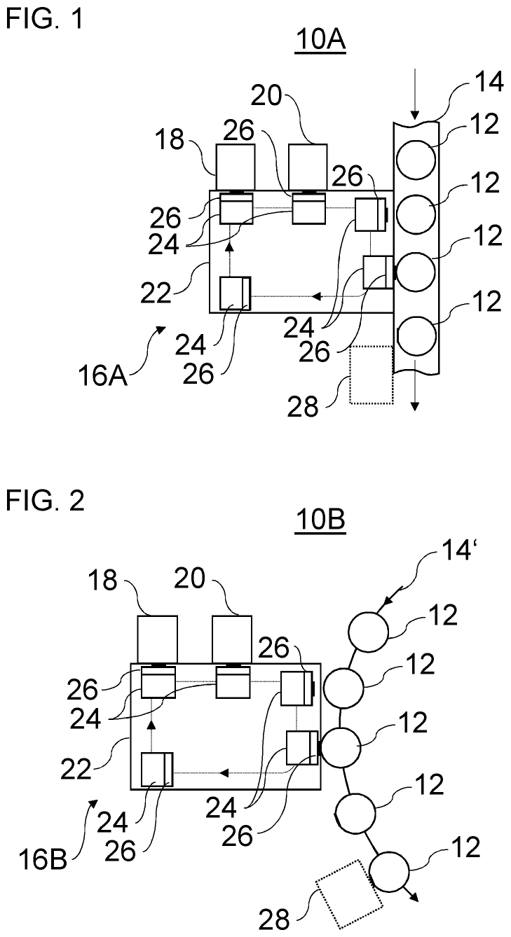

FIG. 1 shows a device 10A for labeling containers 12, e.g. bottles (glass bottles, PET bottles, etc.), cans, etc. The device 10A has a container conveyor 14, a planar drive system 16A, a label dispenser 18 and a gluing unit 20.

The container conveyor 14 conveys the containers 12 preferably in a single-track container flow. The container conveyor 14 can extend linearly, as, for example, is illustrated in FIG. 1. The container conveyor 14 can be designed in any way, for example as a belt conveyor. The container conveyor 14 is arranged next to the planar drive system 16A. The container conveyor 14 and the planar drive system 16A are preferably directly adjacent to each other. The container conveyor 14 conveys the containers 12 along the planar drive system 16A.

The planar drive system 16A is designed to transport labels from the label dispenser 18 to the container conveyor 14 for applying them to the containers 12.

The planar drive system 16A has a base element 22 and a plurality of movement devices (movers or runners) 24. The movement devices 24 can be moved freely and independently of one another over the base element 22 by means of magnetic interaction with the base element 22. The movement devices 24 can also be rotated with respect to the base element 22 (e.g. swiveling) by means of magnetic interaction with the base element 22. The movement devices 24 can also be inclined with respect to the base element 22 (e.g. pitching and/or rolling) by means of magnetic interaction with the base element 22. The movement devices 24 can likewise perform a stroke movement upward or downward relative to the base element 22 by means of magnetic interaction with the base element 22. A number of the movement devices 24 can be freely selectable, depending on the application, with at least one movement device 24 being provided.

The base element 22 forms a stator of the planar drive system 16A. The movement devices 24 form runners of the planar drive system 16A. The movement devices 24 are supported contactlessly by the base element 22. The base element 22 can have, for example, a plurality of electromagnets arranged in a distributed manner, e.g. electric coils. The movement devices 24 can have permanent magnets. The electromagnets are preferably arranged in a matrix which extends in a plane of the base element 22 (here: a horizontal plane). A control unit (not illustrated) of the planar drive system 16A can control a power supply to the electromagnets of the base element 22 to build up electromagnetic fields with a desired field strength at a desired position of the base element 22. Forward propulsion, rotation, inclination and/or a stroke of the movement devices 24 can be brought about by corresponding electromagnetic fields of the electromagnets of the base element 22.

In the exemplary embodiment of FIG. 1, the base element 22 is oriented in a horizontal plane. The base element 22 furthermore has a rectangular shape. Other shapes are also possible for the base element 22, e.g. a circular shape, frame shape, annular shape, etc., depending on requirements. The label dispenser 18 and the gluing unit 20 are arranged next to the base element 22, preferably on the outer side. In the case of a frame shape or annular shape of the base element 22, an inner-side arrangement of the label dispenser 18 and/or of the gluing unit 20 is also possible. It is possible for the label dispenser 18 and/or the gluing unit 20 to protrude over the base element 22 in order to be reached better. The movement devices 24 can be arranged above the base element 22 and, for example, can be rectangular. The movements of the movement devices 24 can be controlled by the control unit of the planar drive system 16A.

The movement devices 24 each have a label holder 26. The label holder 26 is designed to hold a label. The label holder 26 can be embodied, for example, as a label gripper, a label clamping holder, a label suction unit, a label support unit, a labeling pallet or in some other way (with or without an actuator mechanism).

The movement devices 24 can be moved in succession to the label dispenser 18. A label is received at the label dispenser 18. The label can be received by the label holder 26 and/or transferred from the label dispenser 18. In this connection, the movement devices 24 can each stop, slow down, speed up, carry out predetermined movement patterns, etc., depending on the requirements of the respective label dispenser 18. The label is held by the label holder 26.

The label can be moved to the gluing unit 20 by means of the respective movement device 24. The gluing unit 20 can glue the label (e.g. with cold glue or hot glue). For example, the gluing unit 20 may also be embodied as a glue printer.

The label is moved by means of the respective movement device 24 to one of the containers 12 which are conveyed by the container conveyor 14. The movement device 24 moves along with the container 12, preferably at an identical speed, and, in the process, applies the label to the container 12. The application can take place or can be assisted, for example, by means of a feeding movement of the movement device 24 and/or of the label holder 26. For the application, the movement device 24 may also, for example, be rotated (e.g. about its own center axis) and/or inclined with respect to the base surface 22.

It is possible for the containers 12 to have different sizes, e.g. diameters. In such a case, the application of the label can be adapted to the respective size of the container 12. For example, the movement device 24 can always be moved substantially identically close to the respective container 12. The diameters of the containers 12 can be detected previously, for example, by means of a sensor system or can be stored in the control unit as selectable values. The same principle can also be used in the case of different container shapes.

After the application, the respective movement devices 24 can be moved back again to the label dispenser 18 to receive the next label. Preferably, all of the movement devices 24 can be moved independently of one another, preferably on a substantially annular or frame-shaped path with respect to the base element 22.

It is possible for a separate gluing unit 20 not to be included. Instead, the label dispenser 18 may have, for example, an integrated gluing unit, and may dispense already glued labels or dispense self-adhesive labels.

It is also possible for the labels applied to the containers 12 to also be fixed and/or smoothed by an optional label fixing unit 28. For example, the label fixing unit 28 can have a label brushing-on unit for the brushing-on of labels. The label fixing unit 28 can also have a label roll-on sponge for the rolling-on of labels. Alternatively or additionally, the label can already be completely attached to the respective container 12 and fixed and smoothed by the label holder 26.

The containers 12 can be conveyed at different distances or at an unequal spacing by the container conveyor 14. The movement of the movement devices 24 can be adapted thereto, and therefore the movement devices 24 likewise move along the container conveyor 14 at different distances during the application of the label, namely in a manner adapted to the different distances of the containers 12. The different distances between the containers 12 can be detected, for example, by means of a contactless (e.g. optical) or tactile sensor system of the device.

The containers 12 can be conveyed at identical distances by the container conveyor 14, with, however, container gaps being able to occur in the container flow. The movement of the movement devices 24 can be adapted thereto, and therefore none of the movement devices 24 transports a label to a container gap. A container gap can be detected, for example, by means of a contactless (e.g. optical) or tactile sensor system of the device 10A.

FIG. 2 shows a further device 1013 for labeling containers 12.

In contrast to the device 10A from FIG. 1, the device 1013 has a non-rectilinear container conveyor 14′. The containers 12 are instead conveyed on a curved path by the container conveyor 14′, at least in the region of the planar drive system 16B which is designed in the same manner as the planar drive system 16A. The container conveyor 14′ can be embodied, for example, as a carousel or a conveyor carousel.

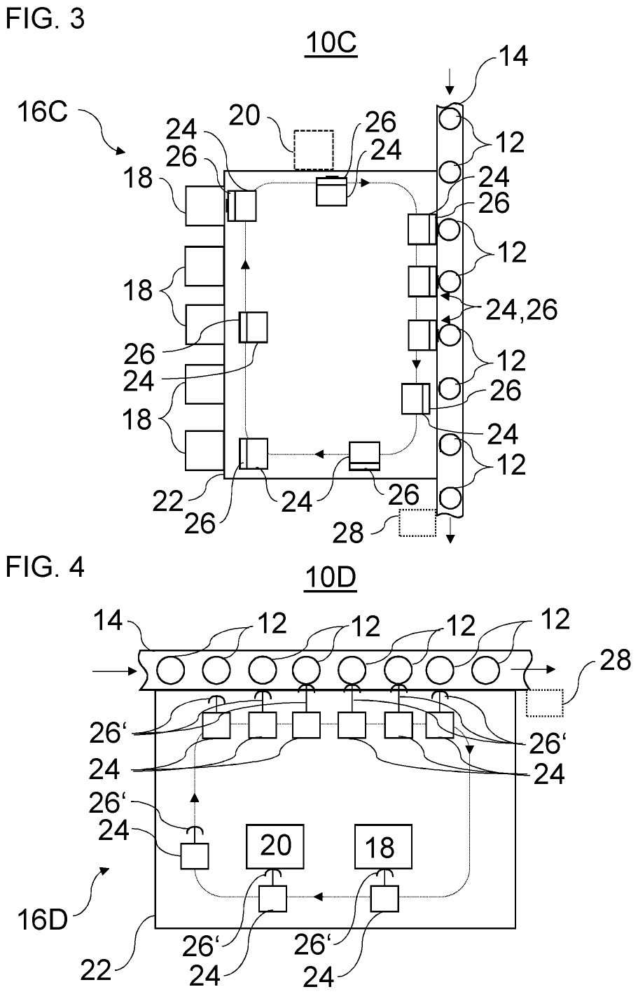

FIG. 3 shows a further device 10C for labeling containers 12. A particular characteristic of the device 10C consists in that the device 10C has a plurality of label dispensers 18.

The device 10C can therefore permit, for example, container-specific labeling, in which the containers 12 can each be equipped with different labels, e.g. on an individual container basis (“labeling on demand”). Specifically, a first movement device 24 can fetch a first label from a first label dispenser 18 and apply it to a first container 12, optionally with intermediate gluing at the gluing unit 20, if required for applying the label. A second movement device 24 can fetch a second label from a second label dispenser 18 and apply it to a second container 12, optionally with intermediate gluing at the gluing unit 20, if required for applying the label, etc. The first label and the second label differ, for example, in shape, size, imprint, etc.

The device 10C can also be used for mixed labeling. In this case, various labels can be applied to the same container 12. Specifically, a first movement device 24 can fetch a first label from a first label dispenser 18 and apply it to a first container 12, optionally with intermediate gluing at the gluing unit 20, if required for applying the label. A second movement device 24 can fetch a second label from a second label dispenser 18 and apply it to the first container 12, optionally with intermediate gluing at the gluing unit 20, if required for applying the label, etc. The first label and the second label differ, for example, in shape, size, imprint, etc.

It is also possible for at least some of the label dispensers 18 to dispense the same label. Therefore, a plurality of movement devices 24 can be supplied, for example in parallel, with the same label for applying to different containers 12. Specifically, a first movement device 24 can fetch a first label from a first label dispenser 18 and apply it to a first container 12, optionally with intermediate gluing at the gluing unit 20, if required for applying the label. A second movement device 24 can fetch a second label from a second label dispenser 18 and apply it to a second container 12, optionally with intermediate gluing at the gluing unit 20, if required for applying the label, etc. The first label and the second label are identical. FIG. 4 shows a further device 10D for labeling containers 12, similarly to the device 10A of FIG. 1.

A particular characteristic of the device 10D consists in that the label dispenser 18 and the gluing unit 20 are not arranged on the outer side of the planar drive system 16D. Instead, the label dispenser 18 and the gluing unit 20 are arranged directly within the circumference or region of the planar drive system 16D. For example, the base element 22 can have a recess for the label dispenser 18 and the gluing unit 20. Alternatively, the label dispenser 18 and the gluing unit 20 could be arranged suspended above the planar drive system 16D. Such a configuration can be, for example, particularly favorable in terms of construction space.

A further particular characteristic of the device 10D consists in that the label holder 26′ (e.g. embodied as a labeling pallet) itself carries out a supply movement to the respective container 12 for applying the label. For example, the label holder 26 can extend in order to apply the label and can retract again after the application of the label, as is illustrated in FIG. 4. It is also possible that, in addition, the label holder 26 or the movement device 24 is rotated and/or inclined with respect to the base element 22 during the application operation.

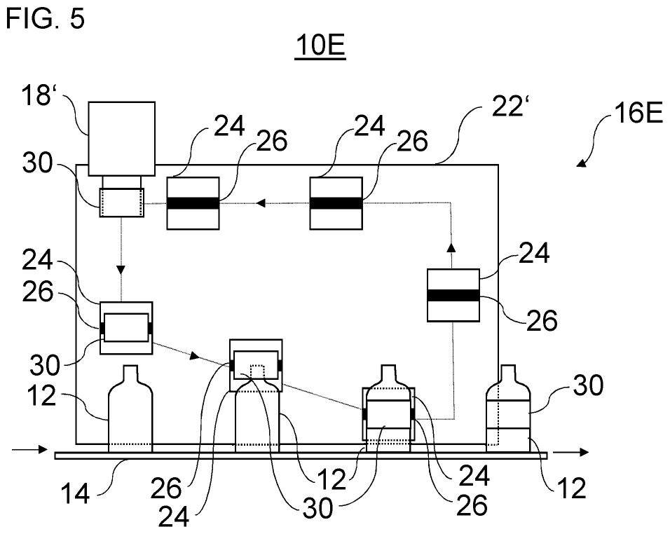

FIG. 5 shows a further device 10E for labeling containers 12.

The device 10E has a label dispenser 18′ which dispenses sleeve labels, what are referred to as sleeves. The label dispenser 18′ can be arranged, for example, above the base element 22′. The base element 22′ is oriented in a vertical plane.

The movement devices 24 move to the label dispenser 18′. At the label dispenser 18′, the label holder 26 of the respective movement device 24 receives an individual sleeve label 30. In the process, the movement device 24 can stop, for example. The sleeve label 30 is held by the label holder 26 in such a manner that it is at least partially spread out. The label dispenser 18′ can transfer the sleeve labels 30, for example, by means of a mandrel which spreads out the sleeve labels 30.

The movement devices 24 move with the held sleeve labels 30 to the container conveyor 14. The movement devices 24 each move along with one of the containers 12, i.e. in a conveying direction of the container conveyor 14 or of the container 12 and with a speed of the container conveyor 14 or of the container 12. During the movement along, the movement device 24 pulls the sleeve label 30 over the respective container 12. In this connection, the movement device 24, as it moves along, can additionally always move further toward the container conveyor 14 or can always be lowered further. In the region of the transfer of the sleeve label 30, the movement path of the movement devices 24 can correspond to a drop section, preferably with a constant drop, as is illustrated in FIG. 5.

During or after the pulling-on operation, the sleeve label 30 is released from the label holder 26, or the sleeve label 30 is automatically released from the label holder 26. The release can be assisted, for example, by means of a rotational movement of the movement device 24 with respect to the base element, by means of an inclination movement of the movement device 24 with respect to the base element 22 and/or by means of a stroke movement of the movement device 24 with respect to the base element 22 for approaching the base element 22.

Finally, the movement device 24 can be moved again to the label dispenser 18′ in order to receive a new sleeve label 30.

It is possible for containers 12 having different diameters to be conveyed by the container conveyor 14. By means of a stroke movement of the movement device 24 with respect to the base element 22, an adaptation to the different diameters can be carried out such that the movement devices 24, even in the event of different container diameters, can be moved substantially always identically closely to the containers 12.

The invention is not restricted to the preferred exemplary embodiments described above. On the contrary, a large number of variants and modifications is possible which likewise make use of the concept of the invention and therefore fall within the scope of protection. In particular, the invention also claims protection for the subject matter and the features of the dependent claims independently of the claims referred to. In particular, the individual features of independent claim 1 are each disclosed independently of one another. In addition, the features of the dependent claims are also disclosed independently of all of the features of independent claim 1 and, for example, independently of the features relating to the presence and/or configuration of the container conveyor, of the at least one label dispenser and/or of the planar drive system of independent claim 1.

### LIST OF REFERENCE SIGNS

10A-10E Device for labeling
12 Container
14 Container conveyor
16A-16E Planar drive system
18 Label dispenser
20 Gluing unit
22 Base element
24 Movement device
26 Label holder
28 Label fixing unit
30 Sleeve label

1. A device for labeling containers, comprising:
a container conveyor for conveying containers;
at least one label dispenser for providing labels; and
a planar drive system which is configured to transport labels from the at least one label dispenser to the container conveyor for applying to the containers.

2. The device as claimed in claim 1, wherein:
the planar drive system comprises a base element and at least one movement device; and
the at least one movement device is movable using magnetic interaction with the base element to the at least one label dispenser for receiving a label and to the container conveyor for applying the received label to a container.

3. The device as claimed in claim 2, wherein:
the at least one movement device comprises a label holder for holding a label.

4. The device as claimed in claim 3, wherein:
the label holder comprises at least one of a label gripper, a label clamping holder, a label suction unit, a label support unit and a labeling pallet.

5. The device as claimed in claim 2, wherein:
the planar drive system is configured such that the at least one movement device moves along with a container on the container conveyor, and, in the process, applies the label to the container.

6. The device as claimed in claim 2, wherein:
the planar drive system is configured such that the at least one movement device stops, slows down, speeds up and/or carries out a predetermined movement pattern at the at least one label dispenser in order to receive the label.

7. The device as claimed in claim 1, wherein:
the at least one label dispenser comprises a sleeve label dispenser for providing sleeve labels; and
the planar drive system is oriented in a vertical plane.

8. The device as claimed in claim 7, wherein:
the planar drive system is configured such that the at least one movement device moves along with a container on the container conveyor, and, in the process, applies the transported sleeve label pulling it over the container.

9. The device as claimed in claim 1, wherein:
the at least one label dispenser comprises a plurality of label dispensers which dispense different labels; and
the planar drive system is configured to transport the different labels from the plurality of label dispensers to different containers for applying to the containers; or
the planar drive system is configured to transport the different labels from the plurality of label dispensers to the identical containers for applying to the containers.

10. The device as claimed in claim 1, wherein:
the at least one label dispenser comprises a plurality of label dispensers which dispense identical labels; and
the planar drive system is configured to transport the identical labels from the plurality of label dispensers to different containers for applying to the containers.

11. The device as claimed in claim 2, wherein:
the containers conveyed by the container conveyor have different sizes and/or shapes; and
the planar drive system is configured to move the at least one movement device substantially always identically closely to the containers having the different sizes and/or shapes for applying the labels.

12. The device as claimed in claim 2, wherein:
the planar drive system is configured to incline the at least one movement device with respect to the base element during the application of the label; and/or
the planar drive system is configured to rotate the at least one movement device with respect to the base element during the application of the label.

13. The device as claimed in claim 2, wherein:
the planar drive system is configured to move the at least one movement device at different distances along the container conveyor for adaptation to different distances between the containers; or
the planar drive system is configured not to move a movement device with a label to a container gap between the otherwise identically spaced-apart containers.

14. The device as claimed in claim 1, further comprising:
a gluing unit for gluing labels, wherein:
the planar drive system is configured to transport the labels from the at least one label dispenser to the gluing unit for gluing and to transport the glued labels to the container conveyor for applying to the containers.

15. The device as claimed in claim 14, wherein:
the at least one movement device is movable by magnetic interaction with the base element to the gluing unit for gluing the received label and/or from the gluing unit to the container conveyor.

16. The device as claimed in claim 2, wherein:
the planar drive system is configured such that the at least one movement device moves along with a container on the container conveyor at the same speed, and, in the process, applies the label to the container.

17. The device as claimed in claim 7, wherein:
the planar drive system is configured such that the at least one movement device moves along with a container on the container conveyor at the same speed, and, in the process, applies the transported sleeve label by pulling it over the container by lowering the at least one movement device.

18. The device as claimed in claim 1, wherein:
the at least one label dispenser comprises a plurality of label dispensers which dispense different labels; and
the planar drive system is configured to transport the different labels from the plurality of label dispensers to different containers for applying to the containers for on-demand labeling on an individual container basis; or
the planar drive system is configured to transport the different labels from the plurality of label dispensers to the identical containers for applying to the containers for mixed labeling of the containers.

19. The device as claimed in claim 2, wherein:
the planar drive system is configured to incline the at least one movement device with respect to the base element during the application of the label for applying the label to an inclined portion of the containers; and/or
the planar drive system is configured to rotate the at least one movement device with respect to the base element about its own center axis, during the application of the label.
